(19) United States
(12) Patent Application Publication
(10) Pub. No.: US 2015/0079344 A1
(43) Pub. Date: Mar. 19, 2015

(54) LAMINATE FILM

(71) Applicant: SUMITOMO CHEMICAL COMPANY, LIMITED, Chuo-ku, Tokyo (JP)

(72) Inventors: Yasuhiro Yamashita, Tsukuba-shi (JP); Toshiya Kuroda, Tsukuba-shi (JP)

(73) Assignee: SUMITOMO CHEMICAL COMPANY, LIMITED, Chuo-ku, Tokyo (JP)

(21) Appl. No.: 14/387,302

(22) PCT Filed: Apr. 11, 2013
(86) PCT No.: PCT/JP2013/061432

§ 371 Date: Sep. 23, 2014

(30) Foreign Application Priority Data
Apr. 19, 2012 (JP) 2012-095802

(51) Int. Cl. B32B 3/30

(52) U.S. Cl. CPC B32B 3/30; B32B 2250/02
USPC 428/141

(57) ABSTRACT

Provided is a laminate film having a substrate and at least one thin film layer which has been formed on at least one surface of the substrate.

### TECHNICAL FIELD

The present invention relates to a laminate film having a thin film layer formed on the surface of a substrate in which an occurrence of cracking in the thin film layer has been inhibited.

### BACKGROUND ART

There is known a laminate film in which a thin film layer has been formed (layered) on the surface of a film substrate to add functionality to the substrate. For example, a laminate film in which gas barrier properties have been provided by forming a thin film layer on a plastic film is suitable for filling and packaging such articles as foods and drinks, cosmetics, and detergents. In recent years, there has been a proposal for the use of laminate films in which a thin film layer comprising inorganic oxides, such as silicon oxide, silicon nitride, silicon oxynitride, or aluminum oxide, has been formed on either surface of a substrate film, such as a plastic film.

Among known methods of thus forming a thin film layer of an inorganic oxide on the surface of a plastic substrate are physical vapor deposition (PVD) methods, such as those for vacuum deposition, sputtering, or ion plating, and chemical vapor deposition (CVD) methods, such as those for low pressure chemical vapor deposition and plasma chemical vapor deposition.

PTL 1 discloses a technique capable of enhancing gas barrier properties by reducing average surface roughness of a film substrate when forming a thin film layer to produce a packaging film with the aforementioned method.

### CITATION LIST

### Patent Literature

[PTL 1] JP-A-11-105190

### SUMMARY OF INVENTION

### Technical Problem

When an attempt is made to further enhance gas barrier properties, however, it is often the case that the undulating shape of the substrate resulting from bumps or dents locally present on the substrate surface is more of a problem than the average surface roughness of the film substrate. This is because the presence of such an undulating part on the substrate surface causes fine cracks in a thin film layer that is formed on the surface of the undulating part or in its vicinity. Thus far, the use of the technique described in PTL 1 alone has failed to enhance gas barrier properties sufficiently because of the circumstances stated above.

The present invention has been made to address the above circumstances, and an object thereof is to provide a laminate film which has a substrate with a flattened surface and is excellent in gas barrier properties.

### Solution to Problem

In order to achieve the above object, the present invention provides a laminate film having a substrate and at least one thin film layer which has been formed on at least either surface of the substrate, in which in a cross-section perpendicular to the surface of the substrate, provided that a direction connecting both ends of the surface at the side of the substrate where the thin film layer has been formed is an X direction and that a direction perpendicular to the X direction is a Y direction, when the substrate has a bump on the surface where the thin film layer has been formed, an intersection point p1 between a line segment x1, which passes through the edge of the bump and runs parallel to the X direction, and a line segment y1, which passes through the apex of the bump and runs parallel to the Y direction, is determined, a distance between the apex on the line segment y1 and the intersection point p1 is denoted as a, a distance between the edge on the line segment x1 and the intersection point p1 is denoted as b, and a thickness of the thin film layer on a flat part of the substrate in the vicinity of the above bump is denoted as h; when the substrate has a dent on the surface where the thin film layer has been formed, an intersection point p2 between a line segment x2, which passes through the edge of the dent and runs parallel to the X direction, and a line segment y2, which passes through the bottom of the dent and runs parallel to the Y direction, is determined, a distance between the bottom on the line segment y2 and the intersection point p2 is denoted as a, a distance between the edge on the line segment x2 and the intersection point p2 is denoted as b, and a thickness of the thin film layer on a flat part of the substrate in the vicinity of the above dent is denoted as h; the cross-section has been set such that a value of a/b becomes maximum; and all of the bumps and dents on the surface satisfy a relationship represented by the following Formula (1).

a/b<0.7(a/h)⁻¹+0.31 (1)

In the laminate film of the present invention, all of the bumps and dents on the surface preferably satisfy a relationship represented by the following Formula (2).

a/h<1.0 (2)

In the laminate film of the present invention, all of the bumps and dents on the surface preferably satisfy a relationship represented by the following Formula (3).

0<a/b<1.0 (3)

In the laminate film of the present invention, an average surface roughness Ra of the surface at the side of the substrate where the thin film layer has been formed preferably satisfies a relationship represented by the following Formula (4).

10Ra<a (4)

In the laminate film of the present invention, an average surface roughness Ra′ of the surface of the thin film layer is preferably 0.1 nm to 5.0 nm.

In the laminate film of the present invention, the thin film layer is preferably the one formed by a plasma CVD method.

The laminate film of the present invention is preferably the one obtained by continuously forming the thin film layer on the long-length substrate, while continuously transporting the substrate.

The laminate film of the present invention is preferably the one obtained after having transported the above substrate in such a manner that the surface is brought into contact one or more times with a transport surface of a transport roll at a wrap angle of less than 120° while applying a tensile stress of 1.5 MPa or greater to the surface of the substrate where the thin film layer is to be formed.

### Advantageous Effects of Invention

The present invention provides a laminate film which has a substrate with a flattened surface and is excellent in gas barrier properties.

### BRIEF DESCRIPTION OF DRAWINGS

FIG. 1 is a view schematically showing an embodiment of the laminate film according to the present invention.

FIG. 2 is a schematic view illustrating a wrap angle at the time of transporting a substrate with a transport roll.

FIG. 3 is a graph showing a relationship between a/b and a/h in laminate films of Examples 1 and 2 and Comparative Example 1.

### DESCRIPTION OF EMBODIMENTS

The laminate film according to the present invention is a laminate film having a substrate and at least one thin film layer which has been formed on at least either surface of the substrate, in which in a cross-section perpendicular to the surface of the substrate, provided that a direction connecting both ends of the surface at the side of the substrate where the thin film layer has been formed is an X direction and that a direction perpendicular to the X direction is a Y direction, when the substrate has a bump on the surface where the thin film layer has been formed, an intersection point p1 between a line segment x1, which passes through the edge of the bump and runs parallel to the X direction, and a line segment y1, which passes through the apex of the bump and runs parallel to the Y direction, is determined, a distance between the apex on the line segment y1 and the intersection point p1 is denoted as a, a distance between the edge on the line segment x1 and the intersection point p1 is denoted as b, and a thickness of the thin film layer on a flat part of the substrate in the vicinity of the above bump is denoted as h; when the substrate has a dent on the surface where the thin film layer has been formed, an intersection point p2 between a line segment x2, which passes through the edge of the dent and runs parallel to the X direction, and a line segment y2, which passes through the bottom of the dent and runs parallel to the Y direction, is determined, a distance between the bottom on the line segment y2 and the intersection point p2 is denoted as a, a distance between the edge on the line segment x2 and the intersection point p2 is denoted as b, and a thickness of the thin film layer on a flat portion in the vicinity of the dent of the substrate is denoted as h; the cross-section is set such that a value of a/b becomes maximum; and all of the bumps and dents within the surface satisfy a relationship represented by the following Formula (1).

a/b<0.7(a/h)⁻¹+0.31 (1)

As described above, since the thin film layer is formed on the substrate such that the relationship represented by the Formula (1) is satisfied, the substrate surface has a high degree of flatness relative to the thin film layer. As a result, even when a bump or a dent is present on the substrate surface, its influence is small, and occurrence of cracking is inhibited on the surface, or in the vicinity of the bump or dent in the thin film layer, resulting in the formation of the laminate film with excellent gas barrier properties.

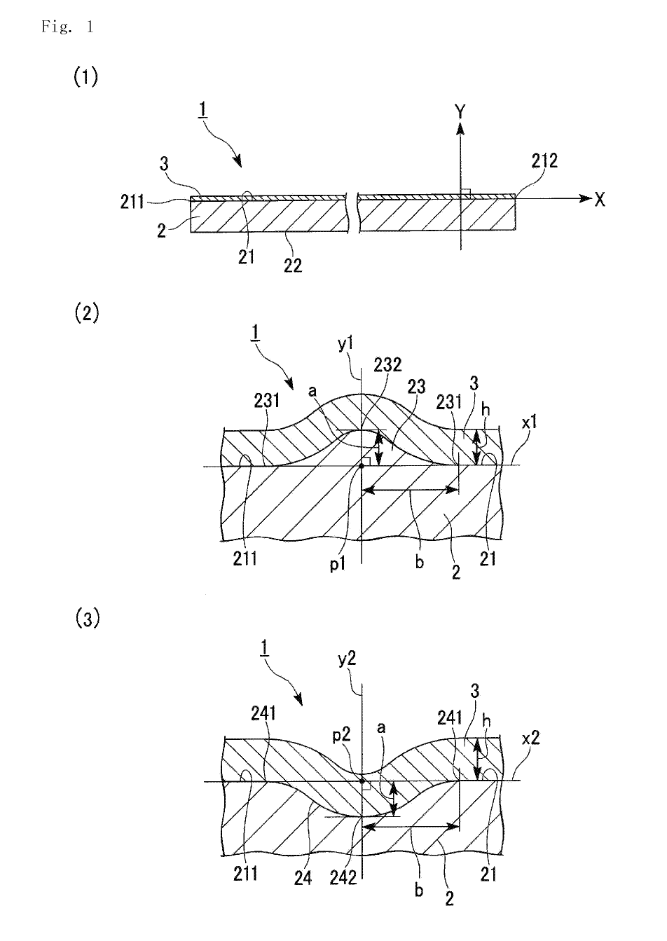

FIG. 1 is a view schematically showing an embodiment of the laminate film according to the present invention. FIG. 1(a) is a cross-sectional view in a direction perpendicular to the substrate surface, FIG. 1(b) is an enlarged cross-sectional view showing the vicinity of the bump of the substrate surface in the same direction, and FIG. 1(c) is an enlarged cross-sectional view showing the vicinity of the dent on the substrate surface in the same direction.

In a laminate film 1 shown in the drawing, one thin film layer 3 (single layer) is formed on a surface 21 (hereinafter sometimes referred to as a “thin film layer-formed surface”) which is one of the two main surfaces of a substrate 2. In the laminate film 1, the thin film layer 3 may be formed not only on the surface 21, one side of the substrate 2, but also on a surface 22, the other side (the surface of the side opposite to the surface 21).

The thin film layer 3 may consist of a single layer or a plurality of layers. In the latter event, all of the layers may be the same or different from each other. Alternatively, only some of the layers may be the same.

The substrate 2 is film-like or sheet-like, and examples of materials thereof include a resin and a composite material containing a resin.

Examples of the resin include polyesters such as polyethylene terephthalate (PET) and polyethylene naphthalate (PEN); polyolefins such as polyethylene (PE), polypropylene (PP), and cyclic polyolefin; polyamide, aramid, polycarbonate, polystyrene, an acrylic resin, a polyvinyl alcohol, a saponified substance of an ethylene-vinyl acetate copolymer, polyacrylonitrile, polyacetal, polyimide, polyether sulfide (PES), a liquid crystal polymer, and cellulose.

Examples of the composite material containing a resin include silicone resins, such as polydimethylsiloxane and polysilsesquioxane; a glass composite material; and a glass epoxy resin.

For the substrate 2, the above materials may be used individually or in combination.

Among them, a material of the substrate 2 is preferably polyester, polyimide, a glass composite substrate, or a glass epoxy substrate since they have strong heat resistance and a low coefficient of linear thermal expansion.

The substrate 2 is preferably colorless and transparent for light to be transmitted or absorbed. Specifically, a total light transmittance of the substrate is preferably 80% or higher and more preferably 85% or higher. Furthermore, a haze of the substrate is preferably 5% or less, more preferably 3% or less, and even more preferably 1% or less.

The substrate 2 is preferably insulative for it to be used as a substrate for electronic devices, energy devices, and the like. An electric resistivity of the substrate is preferably 10⁶ Ωcm or higher.

The thickness of the substrate 2 can be set as appropriate while considering safety at the time of producing the laminate film 1. For example, the thickness is preferably 5 μm to 500 μm since a film of such a thickness can be transported even in a vacuum. When the thin film layer 3 is to be formed by a plasma CVD method as described later, the thickness of the substrate 2 is more preferably 10 μm to 200 μm, and even more preferably 50 μm to 100 μm, since the thin film layer 3 is formed while discharging electricity through the substrate 2.

For adhesion between the substrate 2 and the thin film layer 3 to improve, the substrate 2 is preferably subjected to surface activating treatment beforehand, the treatment being capable of cleaning the surface 21 on which the thin film layer 3 is to be formed. Examples of the surface activating treatment include corona treatment, plasma treatment, UV-ozone treatment, and flame treatment.

The thin film layer 3 preferably contains silicon oxide as a main component, since desired flexibility and gas barrier properties can both be obtained at the same time. Herein, “a main component” means that the content of the component in a material is 50% by mass or more, preferably 70% by mass or more, with respect to the total mass of all components of the material.

The above silicon oxide is the one represented by a formula SiO_{α}, wherein α is preferably a number between 1.0 and 2.0 and more preferably a number between 1.5 and 2.0. α is a value which may be constant or variable in the thickness direction of the thin film layer 3.

The thin film layer 3 may contain silicon, oxygen, and carbon. In this case, the thin film layer 3 preferably contains a compound represented by a Formula SiO_{α}C_{β} as a main component. In the formula, α is selected from among positive numbers of smaller than 2, and β is selected from among positive numbers of smaller than 2. At least one of the α and β in the formula is a value which may be constant or variable in the thickness direction of the thin film layer 3.

The thin film layer 3 may further contain one or more of elements, other than silicon, oxygen, and carbon, such as nitrogen, boron, aluminum, phosphorus, sulfur, fluorine, and chlorine.

The thin film layer 3 may contain silicon, oxygen, carbon, and hydrogen. In this case, the thin film layer 3 preferably contains a compound represented by a formula SiO_{α}C_{β}H_{γ} as a main component. In the formula, α is selected from among positive numbers of smaller than 2, β is selected from among positive numbers of smaller than 2, and γ is selected from among positive numbers of smaller than 6. At least one of the α, β, and γ is a value which may be constant or variable in the thickness direction of the thin film layer 3.

The thin film layer 3 may further contain one or more of elements, other than silicon, oxygen, carbon, and hydrogen, such as nitrogen, boron, aluminum, phosphorus, sulfur, fluorine, and chlorine.

The thin film layer 3 is preferably the one formed by a plasma chemical vapor deposition method (plasma CVD method) as described later.

The thickness of the thin film layer 3 is preferably 5 nm to 3,000 nm, because of the shape of a bump 23 or a dent 24 described later, and also because the laminate film 1 is unlikely to break when it is bent. Moreover, when the thin film layer 3 is to be formed by the plasma CVD method as described later, the thickness is more preferably 10 nm to 2,000 nm, and even more preferably 100 nm to 1,000 nm, since the thin film layer 3 is formed while discharging electricity through the substrate 2.

As shown in FIG. 1(1), in the aforementioned cross-section, the X direction is a direction connecting one end 211 of the thin film layer-formed surface 21 of the substrate 2 and the other end 212 (that is, the X direction connecting both ends). The Y direction is a direction perpendicular to the X direction. Accordingly, with respect to bumps and dents present on the thin film layer-formed surface of the substrate as described later, the X direction can be approximated to the same direction as the horizontal line.

As shown in FIG. 1(2), the substrate 2 has the bump 23 which is locally present on the thin film layer-formed surface 21.

The bump 23 on the thin film layer-formed surface 21 is larger in size than a microscale convexity which may affect the average surface roughness. It derives from, among others, a foreign substance having adhered to the surface 21, a substance having bled from the inside of the substrate 2, a defect of the surface 21 present in the production process, etc.

A sign x1 indicates a line segment which passes through an edge 231 of the bump 23 and runs parallel to the X direction, and a sign y1 indicates a line segment which passes through an apex 232 of the bump 23 and runs parallel to the Y direction. As a result, the line segments x1 and y1 are orthogonal to each other, and a sign p1 indicates an intersection point between the line segment x1 and the line segment y1.

A sign a indicates a distance between the apex 232 on the line segment y1 and the intersection point p1 and corresponds to the height of the bump 23.

A sign b indicates a distance between the edge 231 on the line segment x1 and the intersection point p1 and determines degree of slope of the bump 23.

A sign h indicates the thickness of the thin film layer 3 in a flat part 211 in the vicinity of the bump 23 of the substrate 2.

The edge 231 of the bump 23 is a part that begins ascending toward the apex 232 of the bump 23 from a flat part (for example, the flat part 211 in the drawing) on the thin film layer-formed surface 21 of the substrate 2.

The flat part 211 in the vicinity of the bump 23 is a part that stays flat on the thin film layer-formed surface 21 of the substrate 2 and is also connected to the bump 23, a region that could contain microscale concavities and convexities that may affect the average surface roughness. It can be said that the entire surface 21 is usually flat, except for the bump 23 and the dent 24 which will be described later.

In the present invention, all of the bumps 23 on the thin film layer-formed surface 21 of the substrate 2 satisfy a relationship represented by the following Formula (1).

a/b<0.7(a/h)⁻¹+0.31 (1)

Accordingly, in a case, for example, where the bump 23 is sloped gently enough although the distance a of the bump 23 is large relative to the thickness h of the thin film layer 3, or inversely, in a case where the distance a of the bump 23 is small enough relative to the thickness h of the thin film layer 3 although the bump 23 is sloped steeply, the influence of stress the thin film layer 3 imposes on the bump 23 is small and markedly inhibits occurrence of defects, such as cracks, in the thin film layer 3.

The shape of the bump 23 is not necessarily symmetric to the line segment y1 in the above cross-section. For example, the distance b may take two values. In addition, when two edges 231 of the bump 23 have different heights, there may be two line segments x1, giving sometimes two values for each of the distance a and the distance b. In the present invention, all of the distances a and distances b in the above cross-section are set to satisfy the relationship represented by the Formula (1). Furthermore, taking a look at a specific part, the bump 23, the distance a and the distance b may take differing values, depending also on how to take the cross-section.

In the present invention, as far as the bump 23 goes, the distance a and the distance b are set such that they satisfy the relationship represented by the Formula (1), regardless of how to take the cross-section. That is, the relationship represented by the Formula (1) is made to hold in the cross-section in which the value of “a/b” becomes maximum. Such a cross-section can easily be identified by observing the shape of the bump 23.

As shown in FIG. 1(3), when the dent 24 is locally present on the thin film layer-formed surface 21 of the substrate 2, the bump 23 in FIG. 1(b) may be read to mean the dent 24 with relevant procedures likewise taken specifically stated below.

Similarly to the bump 23, the dent 24 on the thin layer-formed surface 21 is a part larger than a microscale concavity that may affect the average surface roughness. Also similarly to the bump 23, the dent 24 derives from a foreign substance having adhered to the surface 21, a substance having bled from the inside of the substrate 2, a defect of the surface 21 present in the production process, etc.

A sign x2 is a line segment which passes through an edge 241 of the dent 24 and runs parallel to the X direction, and a sign y2 is a line segment which passes through a bottom 242 of the dent 24 and runs parallel to the Y direction. As a result, the line segments x2 and y2 are orthogonal to each other, and a sign p2 is an intersection point between the line segment x2 and the line segment y2.

The sign a indicates a distance between the above bottom 242 on the line segment y2 and the intersection point p2 and corresponds to a depth of the dent 24.

The sign b indicates a distance between the above edge 241 on the line segment x2 and the intersection point p2 and determines degree of slope of the dent 24.

The sign h indicates a thickness of the thin film layer 3 on the flat part 211 in the vicinity of the dent 24 of the substrate 2.

The edge 241 of the dent 24 is a part that begins descending toward the bottom 242 of the dent 24 from a flat part (for example, the flat part 211 in the drawing) on the thin film layer-formed surface 21 of the substrate 2.

The bottom 242 of the dent 24 is where the dent 24 is deepest.

The flat part 211 in the vicinity of the dent 24 is a part which stays flat on the thin film layer-formed surface 21 of the substrate 2 and also is connected to the dent 24, a region that could contain microscale concavities and convexities that may affect the average surface roughness.

In the present invention, all of the dents 24 on the thin film layer-formed surface 21 of the substrate 2 satisfy the relationship represented by the above Formula (1).

Accordingly, similarly to the case of the bump 23, in a case, for example, where the dent 24 is sloped gently enough although the distance a of the dent 24 is large relative to the thickness h of the thin film layer 3, or inversely, in a case where the distance a of the dent 24 is small enough relative to the thickness h of the thin film layer 3 although the dent 24 is sloped steeply, the influence of stress applied to the thin film layer 3 from the dent 24 is small and markedly inhibits the occurrence of defects, such as cracks, in the thin film layer 3.

Similarly to the bump 23, the shape of the dent 24 is not necessarily symmetric to the line segment y2 in the cross-section. For example, the distance b may take two values. In addition, when two edges 241 of the dent 24 have different heights, there may be two line segments x2, giving sometimes two values for each of the distance a and the distance b. In the present invention, all of the distances a and distances b in the above cross-section are set to satisfy the relationship represented by the Formula (1). Furthermore, taking a look at a specific part, the dent 24, the distance a and the distance b may take differing values, depending also on how to take the cross-section. In the present invention, also as far as the dent 24 goes, the distance a and the distance b are set such that they satisfy the relationship represented by the Formula (1), regardless of how to take the cross-section. That is, the relationship represented by the Formula (1) is made to hold in the cross-section in which the value of “a/b” becomes maximum. Such a cross-section can be easily identified by observing the shape of the dent 24, similarly to the case of the bump 23.

As described above, in the present invention, all of the bumps 23 and dents 24 on the thin film layer-formed surface 21 of the substrate 2 satisfy the relationship represented by the Formula (1). Accordingly, when, for example, the thin film layer 2 is formed not only on the surface 21, one side of the substrate 2, but also on the other side, a surface 22, all of the bumps and dents on the surface 22 are set to satisfy the relationship represented by the Formula (1).

In the present invention, the bump 23 and/or the dent 24 preferably satisfy a relationship represented by the following Formula (2). More preferably, all of the bumps 23 and the dents 24 satisfy the relationship represented by the following Formula (2). Also in this case, similarly to the case of the Formula (1), the bump 23 and/or the dent 24 are set to satisfy the relationship represented by the following Formula (2), regardless of how to take the cross-section.

a/h<1.0 (2)

As a result, the distance a of the bump 23 and/or the dent 24 is smaller in number than the above thickness h of the thin film layer 3 (the above thickness h of the thin film layer 3 is greater in number than the distance a). Accordingly, the influence of stress the bump 23 and/or the dent 24 impose on the thin film layer 3 is small and markedly inhibits the occurrence of defects, such as cracks, in the thin film layer 3.

In the present invention, the bumps 23 and/or dents 24 preferably satisfy a relationship represented by the following Formula (3). More preferably, all of the bumps 23 and the dents 24 satisfy the relationship represented by the following Formula (3). Also in this case, similarly to the case of the above Formula (1), the bumps 23 and/or the dents 24 are set to satisfy the relationship represented by the following Formula (3), regardless of how to take the cross-section.

0<a/b<1.0 (3)

As a result, the value of “a/b” of the bump 23 and/or the dent 24, representing the slope of the bump 23 and/or the dent 24, is gentle enough, so that the above surface 21 comes closer to a flat surface with less undulation. Accordingly, the influence of stress the thin film layer 3 imposes on the bump 23 and/or the dent 24 becomes smaller and markedly inhibits the occurrence of defects, such as cracks, in the thin film layer 3.

In the thin film layer-formed surface 21 of the substrate 2, a major axis of the bump 23 and/or the dent (a major axis in a planar view from the above) is preferably 1 nm to 1 mm, more preferably 1 nm to 100 μm, even more preferably 1 nm to 10 μm, and particularly preferably 1 nm to 1 μm. With such a major axis, a thin film layer 3 of greater density can be formed on the substrate 2. Herein, the “major axis” represents a maximal diameter of the bump 23 and the dent 24.

In the present invention, the major axis preferably falls in the above range of numerical values with respect to all of the bumps 23 and the dents 24, since the aforementioned effects become particularly conspicuous in such a range of values.

A total number of the bumps 23 and the dents 24 on the thin film layer-formed surface 21 of the substrate 2 is preferably 1,000/cm² or less, more preferably 100/cm² or less, even more preferably 10/cm² or less, and particularly preferably 1/cm² or less, in which event the thin film layer 3 can be formed on the substrate 2 with higher stability.

In the present invention, an average surface roughness Ra of the thin film layer-formed surface 21 of the substrate 2 preferably satisfies a relationship represented by the following Formula (4) with respect to the bumps 23 and/or the dents 24. More preferably, the Ra satisfies the relationship represented by the following Formula (4) with respect to all of the bumps 23 and the dents 24. Also in this case, similarly to the case of the Formula (1), the relationship represented by the following Formula (4) is to be satisfied with respect to the bump 23 and/or the dents 24, regardless of how to take the cross-section.

10Ra<a (4)

In this manner, if the average surface roughness Ra of the surface 21 is small enough with respect to the distance a of the bump 23 and/or the dent 24, the thin film layer 3 can be formed on the substrate 2 with greater stability.

The average surface roughness Ra can be measured using an atomic force microscope (AFM), for example, in which event the measurement is made preferably in a field of view of 1 μm square.

In the present invention, an average surface roughness Ra′ of the surface of the thin film layer 3 is preferably 0.1 nm to 5.0 nm. In this event, the influence that the surface roughness of the thin film layer 3 may exert is as sufficiently small as negligible, compared to the influence that the bump 23 and/or the dent 24 may exert, so that the thin film layer 3 can be made denser.

The average surface roughness Ra′ of the surface of the thin film layer 3 can be measured by the same method as in the above case of the average surface roughness Ra.

The laminate film 1 can be produced by forming the thin film layer 3 on the thin film layer-formed surface 21 of the substrate 2 with known methods, such as a plasma CVD method. Among others, a continuous film forming process is preferably used for forming the thin film layer 3. More preferably, the thin film layer 3 is continuously formed on the long-length substrate 2 while continuously transporting the substrate 2.

In the production of the laminate film 1, while applying a tensile stress of 1.5 MPa or greater to the thin film layer-formed surface 21 of the substrate 2, the substrate 2 is transported with the surface 21 being brought into contact one or more times with a transport surface of a transport roll at a wrap angle of less than 120°, and thereafter the thin film layer 3 is formed. If a tensile stress of 1.5 MPa or greater is to be applied to the surface 21 of the substrate 2, a tensile stress of 1.5 MPa or greater may be applied to the substrate 2. In this manner, the flatness degree of the surface 21 of the substrate 2 can be raised at a stage prior to the thin film layer 3 being formed, by applying a tensile stress not smaller than a certain value to the surface 21 of the substrate 2 that has the bump 23 and/or the dent 24, and further transporting the substrate 2 while bringing it into contact with the transport surface of the transport roll at a wrap angle not smaller than a certain value. Then, if the thin film layer 3 has been formed on the above surface 21 afterwards, the occurrence of cracking in the thin film layer 3 is inhibited because degree of flatness of the surface 21 relative to the thin film layer 3 is kept high enough, even if the bump 23 and/or the dent 24 is present on the surface 21. When the tensile stress is to be applied to the surface 21 of the substrate 2 as described above, the tensile stress may be applied to the substrate 2 from at least either of the upstream side and downstream side in the transport direction thereof.

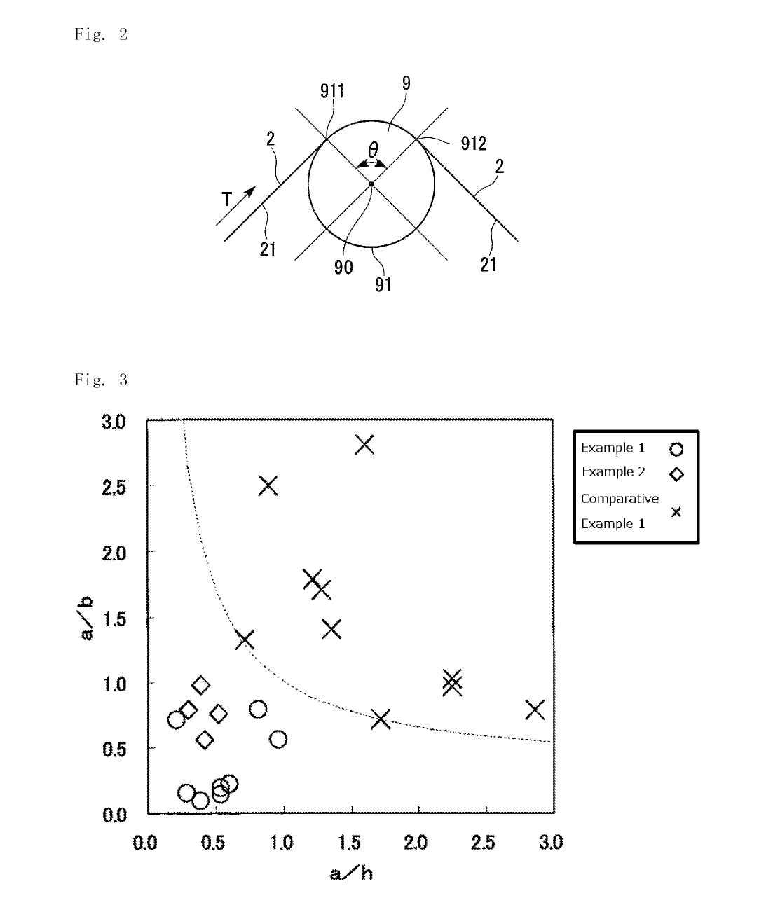

The “wrap angle” herein means as follows. As shown in FIG. 2, when the surface 21 of the substrate 2 is in contact with a transport surface 91 of a transport roll 9 as viewed from the direction of a central axis 90 of a transport roll 9, an angle θ is formed by a line segment connecting a contact part 911, which is in contact with the above transport surface 91 at the upstream side in the transport direction of the substrate 2(direction indicated by arrow T in the drawing) and the above central axis 90, and a line segment connecting a contact part 912, which is in contact with the above transport surface 91 at the downstream side in the transport direction of the substrate 2, and the central axis 90. The angle θ represents the wrap angle.

The wrap angle is more preferably less than 110°, and even more preferably less than 100°. The tensile stress to be applied is more preferably 1.7 MPa or greater, and even more preferably 1.9 MPa or greater. In this manner, the occurrence of cracking in the thin film layer 3 is more effectively inhibited by making the wrap angle smaller and the tensile stress greater.

The transport speed of the substrate 2 at the time of bringing the substrate 2 into contact with the transport roll as described above is preferably 0.1 m/min to 100 m/min, and more preferably 0.5 m/min to 20 m/min. By so doing, the occurrence of cracking in the thin film layer 3 is inhibited more effectively.

The transport surface of the transport roll preferably has a high degree of smoothness. Specifically, the average surface roughness is preferably 0.2 μm or less. The average surface roughness can be measured by the same method as in the above case of the average surface roughness Ra.

As a material of the transport surface of the transport roll, a metal is preferable, and examples thereof include stainless steel, aluminum, and titanium. When the thin film layer 3 is to be formed (film forming) with a plasma CVD method, a method that is preferably employed is the plasma CVD method where the substrate 2 is disposed on a pair of film-forming rolls and plasma is generated by discharging electricity between the pair of film-forming rolls. When electric discharge is to occur between the pair of film-forming rolls in this manner, polarities of the pair of the film-forming rolls are preferably inverted alternately.

When plasma is generated with the plasma CVD method, plasma discharge preferably takes place in a space between a plurality of film-forming rolls. More preferably, the substrate 2 is disposed on each of the pair of film-forming rolls, and plasma is generated by discharging electricity between the pair of film-forming rolls. By disposing the substrate 2 on the pair of film-forming rolls and discharging electricity between the pair of rolls in this manner, a film can be formed on the surface of the substrate 2 present on one of the film-forming rolls, while at the same time, forming a film on the surface of the substrate 2 on the other film-forming roll. As a result, not only can the thin film layer 3 be efficiently formed, but a film formation speed (film formation rate) can be doubled. In addition, the thin film layer 3 is preferably to be formed on the surface of the substrate 2 with a roll-to-roll method since high productivity is gained by so doing. While the apparatus that can be used in producing the laminate film 1 with the plasma CVD method is not particularly limited, the apparatus preferably has at least a pair of film-forming rolls and a plasma power source as well as it being capable of discharging electricity between the above pair of film-forming rolls.

Examples of a film-forming apparatus adopted for the roll-to-roll plasma CVD method include an apparatus which has a feeding roll, a transport roll, a film-forming roll, a transport roll, and a winding-up roll in this order from the upstream side of a film to be formed (an upstream side in the transport direction of a substrate) as well as a gas feed pipe, a power source for generating plasma, and a magnetic field-generating device. Among these, at least the film-forming roll, the gas feed pipe, and the magnetic field-generating device are disposed inside a vacuum chamber when producing the laminate film, the vacuum chamber being connected to a vacuum pump. The internal pressure of the vacuum chamber is controlled by operating the vacuum pump. In the present invention, in a transport roll which is at the upstream side of the film-forming roll in the transport direction of the substrate, the substrate surface may be brought into contact with the transport surface of the transport roll at a wrap angle of less than 120° while applying a tensile stress of 1.5 MPa or greater to the substrate surface as described above. The transport roll, which is brought into contact with the substrate at the tensile stress and wrap angle having been adjusted to prescribed values, may be disposed in any position without particular limitation, so long as it is located further upstream the film-forming roll which is at the most upstream side in the transport direction of the substrate (between the feeding roll and the film-forming roll at the most upstream side).

Preferably, the above film-forming apparatus has a pair of film-forming rolls, and further has a transport roll between the film-forming rolls. In addition, magnetic field-generating devices are preferably installed inside the film-forming rolls in a manner not to change its posture as the film-forming rolls rotate.

When such a film-forming apparatus is used, the substrate 2 wound up around the feeding roll travels from the feeding roll through the transport roll at the most upstream side then to the first (upstream side) film-forming roll. Thereafter, the film substrate in which a thin film has been formed on the surface of the substrate 2 travels from the first film-forming roll through the transport roll then to the second (downstream side) film-forming roll. Next, the obtained laminate film 1 in which the thin film layer 3 has been formed travels from the second film-forming roll through the transport roll located further downstream (the most downstream side) then to the winding-up roll for the film to be wound up around it. In the present invention, the surface 21 may be brought into contact with the transport surface at a wrap angle of less than 120°, while applying a tensile stress of 1.5 MPa or greater to the thin film layer-formed surface 21 of the substrate 2 in the first transport roll.

In the above film-forming apparatus, the pair of film-forming rolls (the first and second film-forming rolls) is disposed so as to face each other. Axes of these film-forming rolls are substantially in parallel with each other, and diameters of these film-forming rolls are substantially the same as each other. With such a film-forming apparatus, a film is formed when the substrate 2 is being transported on the first film-forming roll and also when the above film substrate is being transported on the second film-forming roll.

In the above film-forming apparatus, plasma can be generated in a space interposed between the pair of film-forming rolls. The power source for generating plasma is electrically connected to electrodes in the film-forming rolls, and these electrodes are disposed in a manner to have the above space interposed in between.

The above film-forming apparatus can generate plasma with the power supplied to the above electrodes from the power source for plasma generation. The power source for generating plasma can be known power sources or others as appropriate, such as an alternating current power source that can alternately invert the polarities of the aforementioned two electrodes. For a film to be formed efficiently, the power supplied from the power source for generating plasma is set at 0.1 kW to 10 kW, for example and a frequency of the alternating current at 50 Hz to 500 kHz, for example.

The magnetic field-generating device disposed inside the film-forming roll can generate a magnetic field in the aforementioned space. The device may generate a magnetic field such that magnetic flux density varies in the transport direction on the film-forming roll.

The gas feed pipe can supply gas for forming the thin film layer 3 to the above space. The feed gas contains raw material gas for the thin film layer 3. The raw material gas supplied through the gas feed pipe is decomposed by the plasma generated in the above space to generate film components of the thin film layer 3. The film components of the thin film layer 3 deposit on the substrate 2 or the above film substrate that is transported on the pair of film-forming rolls.

The raw material gas that can be used is organic silicon compounds containing silicon, for example. Examples of such organic silicon compounds include hexamethyldisiloxane, 1,1,3,3-tetramethyldisiloxane, vinyltrimethylsilane, methyltrimethylsilane, hexamethyldisilane, methylsilane, dimethylsilane, trimethylsilane, diethylsilane, propylsilane, phenylsilane, vinyltriethoxysilane, vinyltrimethoxysilane, tetramethoxysilane, tetraethoxysilane, phenyltrimethoxysilane, methyltriethoxysilane, and octamethylcyclotetrasiloxane. Among these organic silicon compounds, hexamethyldisiloxane and 1,1,3,3-tetramethylsiloxane are preferable since these compounds are superior in ease of handling and gas barrier properties of the obtained thin film layer. These organic silicon compounds can be used individually or in combination.

As a raw material gas, monosilane may be contained in addition to the organic silicon compound for use as a silicon source for a barrier film to be formed.

The feed gas may contain reactant gas in addition to the raw material gas. The reactant gas that is used may be the one selected as appropriate from among gases that react with the raw material gas to make an inorganic compound, such as oxides or nitrides. Examples of the reactant gas for forming oxides include oxygen and ozone. Examples of the reactant gas for forming nitrides include nitrogen and ammonia. These reactant gases can be used individually or in combination. For example, when oxynitrides are to be formed, the reactant gas for forming oxides and the reactant gas for forming nitrides may be used in combination.

The feed gas may contain at least either of the carrier gas and discharging gas. The carrier gas that is used may be the one selected as appropriate from among gases for accelerating supply of the raw material gas into the vacuum chamber. The electric discharging gas that is used may be the one selected as appropriate from among gases for accelerating an occurrence of plasma discharge in a space SP. Examples of the carrier gas and the electric discharging gas include noble gas, such as helium gas, argon gas, neon gas, and xenon gas; and hydrogen gas. Both of the carrier gases and electric discharging gases may be used individually or in combination.

Below explained is an example case of producing a silicon-oxygen-based thin film layer. The feed gas used in this example contains hexamethyldisiloxane (organic silicon compound:HMDSO:(CH₃)₆Si₂O) as raw material gas and oxygen (O₂) as reactant gas.

If the feed gas G containing hexamethyldisiloxane and oxygen is reacted when a plasma CVD method is employed, silicon dioxide is generated by a reaction represented by the following Formula (A).

(CH₃)₆Si₂O+12O₂→6CO₂+9H₂O+2SiO₂ (A)

A ratio of the amount of reactant gas to the amount of raw material gas in the feed gas is set such that the ratio is not excessively high as compared, for example, to a ratio stoichiometrically required (stoichiometric ratio) for completely reacting the raw material gas. For example, in the reaction represented by Formula (A), the amount of oxygen stoichiometrically required for completely oxidizing 1 mol of hexamethyldisiloxane is 12 mol. That is, when the amount of oxygen contained in the feed gas G is 12 mol or more with respect to 1 mol of hexamethyldisiloxane, a uniform silicon dioxide film is theoretically formed as a thin film layer. In reality, however, a part of the supplied reactant gas fails to contribute to the reaction in some cases. For this reason, the gas containing the reactant gas in a ratio higher than the stoichiometric ratio is usually fed so that the raw material gas can react completely. The molar ratio of the reactant gas to the raw material gas at which the raw material gas can practically react completely (the ratio hereinafter referred to as “effective ratio”) can be obtained by experiment, etc. For example, when hexamethyldisiloxane is to be oxidized completely with a plasma CVD method, the molar amount (flow rate) of oxygen is set in some cases 20 times (effective ratio of 20) or more the molar amount (flow rate) of the raw material hexamethyldisiloxane. Thus, a ratio of the amount of reactant gas to the amount of raw material gas in the feed gas may be lower than the effective ratio (for example, 20) or equal to a stoichiometric ratio (for example, 12), or may be a value lower than a stoichiometric ratio (for example, 10).

In the present example, if the reaction conditions are set such that the amount of reactant gas is insufficient to make the raw material gas react completely, carbon atoms or hydrogen atoms in the hexamethyldisiloxane that have failed to completely react are taken into the thin film layer. For example, a thin film layer satisfying certain prescribed conditions can be formed by controlling as appropriate, within the above film-forming apparatus, one or more of such parameters as the type of raw material gas, the ratio of a molar amount of reactant gas to a molar amount of raw material gas in the feed gas, power supplied to electrodes, internal pressure of the vacuum chamber, diameter of the pair of film-forming rolls, and transport speed of the substrate 2 (film substrate). Incidentally, one or more of the above parameters may temporally change while the substrate 2 (film substrate) passes through the inside of a film-forming area facing the aforementioned space, or may spatially change within the film-forming area.

The power supplied to electrodes can be controlled as appropriate depending on the type of raw material gas, internal pressure of the vacuum chamber, etc. For example, the power can be set at between 0.1 kW and 10 kW. If the power is 0.1 kW or greater, generation of particles can be inhibited more effectively. If the power is 10 kW or less, the substrate 2 (film substrate) is inhibited more effectively from being wrinkled or damaged due to heat received from electrodes. Furthermore, it is possible to avoid occurrence of abnormal electric discharge that may take place between the pair of film-forming rolls due to damage of the substrate 2 (film substrate), preventing the film-forming rolls from being damaged owing to the abnormal electric discharge.

The internal pressure (degree of vacuum) of the vacuum chamber can be controlled as appropriate depending on the type of raw material gas, etc. The internal pressure can be set at between 0.1 Pa and 50 Pa, for example.

While the transport speed (line speed) of the substrate 2 (film substrate) can be controlled as appropriate depending on the type of raw material gas, the internal pressure of the vacuum chamber, etc., the transport speed preferably is the same as the transport speed of the substrate 2 at the time of the substrate 2 being brought into contact with the transport roll as described above. If the transport speed is equal to or higher than the lower limit, the substrate 2 (film substrate) is inhibited more effectively from being wrinkled.

If the transport speed is equal to or lower than the upper limit, the thickness of the thin film layer to be formed can easily be increased.

A film-forming apparatus that can be used for producing the laminate film according to the present invention is not limited to the aforementioned apparatus. A configuration thereof may be partially modified as appropriate so long as the modification does not impair the effects of the present invention.

As necessary, the laminate film according to the present invention may have one or more of a primer coating layer, a heat-sealable resin layer, an adhesive layer, etc. in addition to the substrate and the thin film layer. The primer coating layer can be formed, using a known primer coating agent capable of enhancing adhesion to the substrate and the thin film layer. The heat-sealable resin layer can be formed, using an appropriate known heat-sealable resin. The adhesive layer can be formed, using an appropriate known adhesive, and a plurality of laminate films may be bonded to each other with such an adhesive layer.

In the laminate film according to the present invention, an occurrence of cracking in the thin film layer is inhibited, so that the laminate film is excellent in gas barrier properties. For example, a thin film layer can be provided also with flexibility if it is made to contain silicon oxide as a main component, a layer, for example, in which the content of silicon oxide is 50% by mass or more with respect to the mass of all components of the material.

### EXAMPLES

Hereinafter, the present invention will be described in more detail based on specific examples. The present invention is not, however, limited to the examples given below. The following methods were adopted to measure or observe bumps and dents locally present on the thin film layer-formed surface of the substrate or to determine whether or not the thin film layer had cracks.

<Identification of Bumps and Dents by a Laser Microscope>

Using a laser microscope, the laminate film was scanned in an in-plane direction of the surface of the thin film layer to identify bumps and dents locally present on the thin film layer-formed surface of the substrate.

<Observation of Cross-Section of Bumps and Dents by TEM>

The bumps and dents were treated with a focused ion beam (FIB) process to prepare cross-sections of the laminate film passing through the central part of the bumps and dents. Thereafter, using a transmission electron microscope (TEM), images of the cross-sections were obtained. For the bumps and dents observed from the obtained images of the cross-sections, the values of a and b were determined, and a value of a/b was calculated. From the obtained images of the cross-sections, the thickness h of the thin film layer was determined, and it was examined whether or not cracks were present in a region in the vicinity of the above bumps or dents in the thin film layer.

<Measurement of Average Surface Roughness of Substrate Surface and Thin Film Layer Surface>

Using an atomic force microscope (AFM, “SPA400” manufactured by Seiko Instruments Inc.), average surface shape was checked with respect to the substrate surface and the thin film layer surface. For the site free of bumps and dents, average surface roughness was measured in a field of view of 1 μm square.

### Example 1

A laminate film was produced with the production method described above. A glass cloth composite film (“Sumilite TTR film” manufactured by SUMITOMO BAKELITE CO., LTD., thickness of 90 μm, width of 350 mm, length of 100 m) was used as a substrate and mounted on the feeding roll. Using a turbo molecular pump, the inside of the vacuum chamber was kept under reduced pressure for 12 hours, and then a thin film layer was formed. During the film formation, on a metallic free roll which was disposed further upstream the film-forming roll located at the most upstream side in the transport direction of the substrate, the substrate was transported with the thin film layer-formed surface of the substrate brought into contact with the transport surface of the transport roll at a wrap angle of 90° while applying a tensile stress of 1.9 MPa to the substrate from both the upstream side and downstream side in the transport direction of the substrate. The average surface roughness Ra of the substrate surface was 0.9 nm. A magnetic field was applied to the space between the pair of film-forming rolls, and at the same time electricity was supplied to each of the film-forming rolls to discharge electricity between the film-forming rolls, thereby generating plasma. To the discharge region was supplied mixed gas consisting of film-forming gas (hexamethyldisiloxane (HMDSO) as raw material gas) and oxygen gas as reactant gas (also functioning as electric discharging gas) to form a thin film layer with a plasma CVD method under the following film-forming conditions, thereby producing a laminate film.

<Film-Forming Condition 1>

Amount of raw material gas supplied: 50 standard cubic centimeters per minute (sccm, based on 0° C. and 1 atm)

Amount of oxygen gas supplied: 500 sccm (based on 0° C. and 1 atm)

Internal pressure of vacuum chamber: 3 Pa

Power supplied from power source for generating plasma: 0.8 kW

Frequency of power source for generating plasma: 70 kHz

Transport speed of substrate: 0.5 m/min

With respect to the obtained laminate film, a total of 8 bumps and dents locally present on the substrate surface were identified, and the film was treated with an FIB process to prepare cross-sections of the laminate film. By observing the cross-sections with a TEM, a value of a and a value of b for the bumps and dents were determined and, a value of a/b was then calculated to determine the thickness h of the thin film layer. The results are shown in Table 1. FIG. 3 is a graph showing the relationship between a/b and a/h.

In any of the cross-sections, no cracks were observed in the vicinity of the bumps or dents in the thin film layer, and it was confirmed that the laminate film obtained was capable of sufficiently inhibiting deterioration in gas barrier properties attributable to cracking. The average surface roughness Ra′ of the thin film layer was 1.6 nm with respect to the obtained laminate film.

### Example 2

A laminate film was obtained in the same manner as in Example 1, except that a polyethylene terephthalate film (“Teonex Q65FA” manufactured by Teijin DuPont Films Japan Limited, thickness of 100 μm, width of 700 mm, length of 100 m, average surface roughness Ra: 1.1 nm) was used as a substrate, instead of the “glass cloth composite film (“Sumilite TTR film” manufactured by SUMITOMO BAKELITE CO., LTD., thickness of 90 μm, width of 350 mm, length of 100 m, average surface roughness Ra: 0.9 nm)”; and the thin film layer was formed under Film-forming condition 2, instead of Film-forming condition 1.

<Film-Forming Condition 2>

Amount of raw material gas supplied: 100 standard cubic centimeters per minute (sccm, based on 0° C. and 1 atm)

Amount of oxygen gas supplied: 900 sccm (based on 0° C. and 1 atm)

Internal pressure of vacuum chamber: 1 Pa

Power supplied from power source for generating plasma: 1.6 kW

Frequency of power source for generating plasma: 70 kHz

Transport speed of substrate: 0.5 m/min

With respect to the obtained laminate film, a total of 4 bumps and dents locally present on the substrate surface were identified, and the film was treated with an FIB process to prepare cross-sections of the laminate film. By observing the cross-sections with a TEM, a value of a and a value of b for the bumps and dents were determined, and a value of a/b was then calculated to determine the thickness h of the thin film layer. The results are shown in Table 1. FIG. 3 is a graph showing the relationship between a/b and a/h.

In any of the cross-sections, no cracks were observed in the vicinity of the bumps or dents in the thin film layer, and it was confirmed that the laminate film obtained was capable of sufficiently inhibiting deterioration in gas barrier properties attributable to cracking. The average surface roughness Ra′ of the thin film layer was 1.3 nm with respect to the obtained laminate film.

### Comparative Example 1

A laminate film was obtained, and the presence of cracks was examined, in the same manner as in Example 1, except that the tensile stress applied to the substrate during the substrate transportation was 0.5 MPa, instead of 1.9 MPa and the wrap angle was 120°, in place of 90°. The results are shown in Table 1 and FIG. 3.

With respect to the obtained laminate film, a total of 10 bumps and dents locally present on the substrate surface were identified, and the film was treated with an FIB process to prepare cross-sections of the laminate film. By observing the cross-sections with a TEM, a value of a and a value of b for the bumps and dents were determined, and a value of a/b was then calculated to determine the thickness h of the thin film layer. The results are shown in Table 1. FIG. 3 is a graph showing the relationship between a/b and a/h.

In all of the cross-sections, cracks penetrating through the thin film layer in the thickness direction were observed in the vicinity of the bumps or dents in the thin film layer.

TABLE 1

| | Bump | | | | | | |
|---|---|---|---|---|---|---|---|
| | or | | | | | | |
| | dent | a | b | h | | | |
| | (No.) | (nm) | (nm) | (nm) | a/b | a/h | Cracks |
| Example 1 | 1 | 110 | 1250 | 280 | 0.09 | 0.39 | Absent |
| (Ra = 0.9 | 2 | 80 | 530 | 280 | 0.15 | 0.29 | Absent |
| nm) | 3 | 150 | 1100 | 280 | 0.14 | 0.54 | Absent |
| | 4 | 170 | 760 | 280 | 0.22 | 0.61 | Absent |
| | 5 | 150 | 780 | 280 | 0.19 | 0.54 | Absent |
| | 6 | 60 | 85 | 280 | 0.71 | 0.21 | Absent |
| | 7 | 270 | 480 | 280 | 0.56 | 0.96 | Absent |
| | 8 | 230 | 290 | 280 | 0.79 | 0.82 | Absent |
| Example 2 | 1 | 130 | 170 | 250 | 0.76 | 0.52 | Absent |
| (Ra = 1.1 | 2 | 105 | 188 | 250 | 0.56 | 0.42 | Absent |
| nm) | 3 | 98 | 100 | 250 | 0.98 | 0.39 | Absent |
| | 4 | 75 | 95 | 250 | 0.79 | 0.30 | Absent |
| Comparative | 1 | 630 | 610 | 280 | 1.03 | 2.25 | Present |
| Example 1 | 2 | 380 | 270 | 280 | 1.41 | 1.36 | Present |
| (Ra = 0.9 | 3 | 800 | 1010 | 280 | 0.79 | 2.86 | Present |
| nm) | 4 | 340 | 190 | 280 | 1.79 | 1.21 | Present |
| | 5 | 630 | 650 | 280 | 0.97 | 2.25 | Present |
| | 6 | 480 | 670 | 280 | 0.72 | 1.71 | Present |
| | 7 | 360 | 210 | 280 | 1.71 | 1.29 | Present |
| | 8 | 450 | 160 | 280 | 2.81 | 1.61 | Present |
| | 9 | 200 | 150 | 280 | 1.33 | 0.71 | Present |
| | 10 | 250 | 100 | 280 | 2.50 | 0.89 | Present |

From the above results, it was confirmed that the laminate film according to the present invention was superior in gas barrier properties, its substrate surface has a high degree of flatness and occurrence of cracking in the thin film layer has been inhibited.

### INDUSTRIAL APPLICABILITY

The present invention can be used as a gas barrier film.

### REFERENCE SIGNS LIST

1 laminate film
2 substrate
21 thin film layer-formed surface of substrate
211 flat part of substrate surface
23 bump
231 edge of bump
232 apex of bump
24 dent
241 edge of dent
242 bottom of dent
3 thin film layer
9 transport roll
90 central axis of transport roll
91 transport surface of transport roll
911 contact part of substrate that comes into contact with transport surface of transport roll (upstream side)
912 contact part of substrate that comes into contact with transport surface of transport roll (downstream side)
T transport direction of substrate
θ wrap angle

1. A laminate film comprising:
a substrate; and
at least one thin film layer which has been formed on at least one surface of the substrate,
wherein in a cross-section perpendicular to the surface of the substrate, provided that a direction connecting both ends of the surface at the side of the substrate where the thin film layer has been formed is an X direction and that a direction perpendicular to the X direction is a Y direction, when the substrate has a bump on the surface where the thin film layer has been formed, an intersection point p1 between a line segment x1, which passes through the edge of the bump and runs parallel to the X direction, and a line segment y1, which passes through the apex of the bump and runs parallel to the Y direction, is determined, a distance between the apex on the line segment y1 and the intersection point p1 is denoted as a, a distance between the edge on the line segment x1 and the intersection point p1 is denoted as b, and a thickness of the thin film layer on a flat part of the substrate in the vicinity of the above bump is denoted as h;
when the substrate has a dent on the surface where the thin film layer has been formed, an intersection point p2 between a line segment x2, which passes through the edge of the dent and runs parallel to the X direction, and a line segment y2, which passes through the bottom of the dent and runs parallel to the Y direction, is determined, a distance between the bottom on the line segment y2 and the intersection point p2 is denoted as a, a distance between the edge on the line segment x2 and the intersection point p2 is denoted as b, and a thickness of the thin film layer on a flat part of the substrate in the vicinity of the above dent is denoted as h;
the cross-section is set such that a value of a/b becomes maximum; and
all of the bumps and dents on the surface satisfy a relationship represented by the following Formula (1).
a/b<0.7(a/h)⁻¹+0.31 (1)

2. The laminate film according to claim 1,
wherein all of the bumps and dents on the surface satisfy a relationship represented by the following Formula (2).
a/h<1.0 (2)

3. The laminate film according to claim 1,
wherein all of the bumps and dents on the surface satisfy a relationship represented by the following Formula (3).
0<a/b<1.0 (3)

4. The laminate film according to claim 1,
wherein an average surface roughness Ra of the surface at the side of the substrate where the thin film layer has been formed satisfies a relationship represented by the following Formula (4).
10Ra<a (4)

5. The laminate film according to claim 1,
wherein an average surface roughness Ra′ of the surface of the thin film layer is 0.1 nm to 5.0 nm.
